(19) United States
(12) Patent Application Publication
(10) Pub. No.: US 2012/0250879 A1
(43) Pub. Date: Oct. 4, 2012

(54) MEDIA AND COMMUNICATION SYSTEM

(75) Inventor: ROY MOODY, Auckland (NZ)

(73) Assignee: PHITEK SYSTEMS LIMITED, Newmarket (NZ)

(21) Appl. No.: 13/435,378

(22) Filed: Mar. 30, 2012

Related U.S. Application Data
(60) Provisional application No. 61/469,550, filed on Mar. 30, 2011.

(51) Int. Cl. H04B 1/00; H04N 7/18

(52) U.S. Cl. 381/86; 348/77; 348/E07.085

(57) ABSTRACT

A media and video communication system is described that may be used, for example, in an aircraft. The disclosed system includes a camera for capturing an image of a user, and a video display unit (VDU) for displaying an image on a screen. A microphone or array of microphones may also be provided. One microphone may be configured to capture the voice of the user, enabling video communication. An additional microphone or microphones may be used to capture ambient noise to feed into a noise cancellation circuit.

### CROSS REFERENCE TO RELATED APPLICATIONS

This application claims priority to U.S. Provisional Application 61/469,550, titled “Media and Communication System,” filed Mar. 30, 2011. The foregoing is incorporated by reference.

### BACKGROUND OF THE INVENTION

1. Field of the Invention

The present invention relates to communication and entertainment systems, and has particular relevance to passenger communication or entertainment, for example in-flight entertainment (“IFE”) systems.

2. Background

In-flight entertainment (“IFE”) systems are now common-place on commercial passenger aircraft.

As technology changes, particularly advances in communications technologies, in-flight entertainment systems need to be upgraded to satisfy passenger requirements. Increasingly, aircraft passengers wish to interconnect their own component devices such as communication or data processing devices to aircraft systems, even if it is only to obtain a suitable power supply for a passenger device such as a personal media player or laptop. This particular demand can vary between customers and can include data connections such as USB, headphone, earphone, media player, laptop, and wireless devices, among others.

Video conferencing services and technologies such as video over IP including that offered by SKYPE are becoming commonplace. As such there is a market for such services in passenger vehicles such as aircraft.

3. Object of the Invention

It is an object of the invention to provide a video and/or audio system or interface for use in a passenger environment. It is also an object of the invention to provide apparatus for facilitating implementation of a video and/or audio system or interface which will at least go some way to overcoming disadvantages of existing systems, or which will at least provide a useful alternative to existing systems.

Further objects of the invention will become apparent from the following description.

### BRIEF DESCRIPTION OF THE DRAWINGS

One or more embodiments of the invention will be disclosed below with reference to the accompanying drawings in which

FIG. 1 is a diagrammatic side elevation of an existing or known IFE connector configuration;

FIG. 2 is a diagrammatic side elevation of one embodiment of a new IFE connector configuration;

FIG. 2A is a diagrammatic illustration of a connector module separated from a connector module receiver;

FIG. 3 is an isometric view from above of a connector module receiver including three connector modules;

FIG. 4 is an isometric view from below of the assembly of FIG. 3;

FIG. 5 is a further isometric view from below of the assembly of FIG. 3, but now showing the other end of the assembly;

FIG. 6 is an isometric view from above of the assembly of FIG. 3, but with two of the connector modules removed from the receiver;

FIG. 7 is a further isometric view from above of the assembly of FIG. 3 with two of the connector modules removed from the receiver, and showing further detail inside the pockets of the receiver that receive the connector modules;

FIG. 8 is a further isometric view of FIG. 7 from another angle;

FIG. 9 is a further isometric view from above of the assembly of FIG. 3, showing the upper surfaces of the connector modules and the receiver in greater detail;

FIG. 10 is an isometric view from above of a connector module;

FIG. 11 is an isometric view of the connector module of FIG. 10 from below;

FIG. 12 is a plan of the connector module of FIG. 10 from above;

FIG. 13 is a plan view of the connector module of FIG. 10 from below;

FIG. 14 is a side elevation of the connector module of FIG. 10;

FIG. 15 is a side elevation of the connector module of FIG. 10 from the opposite side from that shown in FIG. 14;

FIG. 16 is an end elevation of the connector module of FIG. 10;

FIG. 17 is an end elevation of the connector module of FIG. 10 shown from the opposite side to that shown in FIG. 16;

FIG. 18 is a perspective view of a locking member;

FIG. 19 is a side elevation and an end elevation of the locking member of FIG. 18;

FIG. 20 Is a side elevation (other side to that shown in FIG. 19) and an end elevation

(other end to that shown in FIG. 19) of the locking member of FIG. 18;

FIG. 21 is an isometric view from below of a faceplate for use with the assembly of FIG. 3;

FIG. 22 is a diagrammatic exploded view of a VDU in accordance with an embodiment of the invention.

FIG. 23 is a diagrammatic front view of a VDU and an associated headset in accordance with an embodiment of the invention.

### SUMMARY OF THE INVENTION

In one aspect the disclosed subject matter provides a passenger visual display unit (VDU) having a camera associated therewith, the camera being adapted to capture an image of the passenger.

In one embodiment the camera is incorporated in a housing of the VDU.

In another embodiment the camera is incorporated in a screen surround of the VDU.

In another aspect the disclosed subject matter provides a passenger visual display unit (VDU) including an image processor for providing an image captured by a camera in an appropriate digital format for provision to a communications or information system.

In one embodiment the communications or information system comprises an IFE system.

In one embodiment the processor comprises a video codec.

In one embodiment the VDU includes one or more microphones adapted to receive a voice signal from the passenger. In one embodiment an array of microphones is provided. The array may be directed to receive sound from the passenger and substantially exclude sound from the area adjacent to the passenger. In another embodiment an audio signal processor filters unwanted sound from the audio signal received from the one or more microphones.

In another aspect the disclosed subject matter provides a video communication system for a vehicle passenger, the system including an image processor for providing an image captured by a camera in an appropriate digital format for provision to a communications or information system.

In one embodiment the system includes an audio interface to provide a voice signal from the passenger in an appropriate digital format for provision to a communications or information system.

The codec in one embodiment includes one or more of the following functions:

Face recognition optimization

Image stabilization

Autofocus

The system in one embodiment includes self identification of an audio device such as a microphone and/or headphone.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

Further aspects of this invention which should be considered in all its novel aspects will become apparent from the following description given by way of example of a possible embodiment thereof.

### DETAILED DESCRIPTION OF THE EMBODIMENTS

The invention is described below with reference to an IFE system, but those skilled in the art will appreciate that the invention may be applicable to other types of passenger communication apparatus.

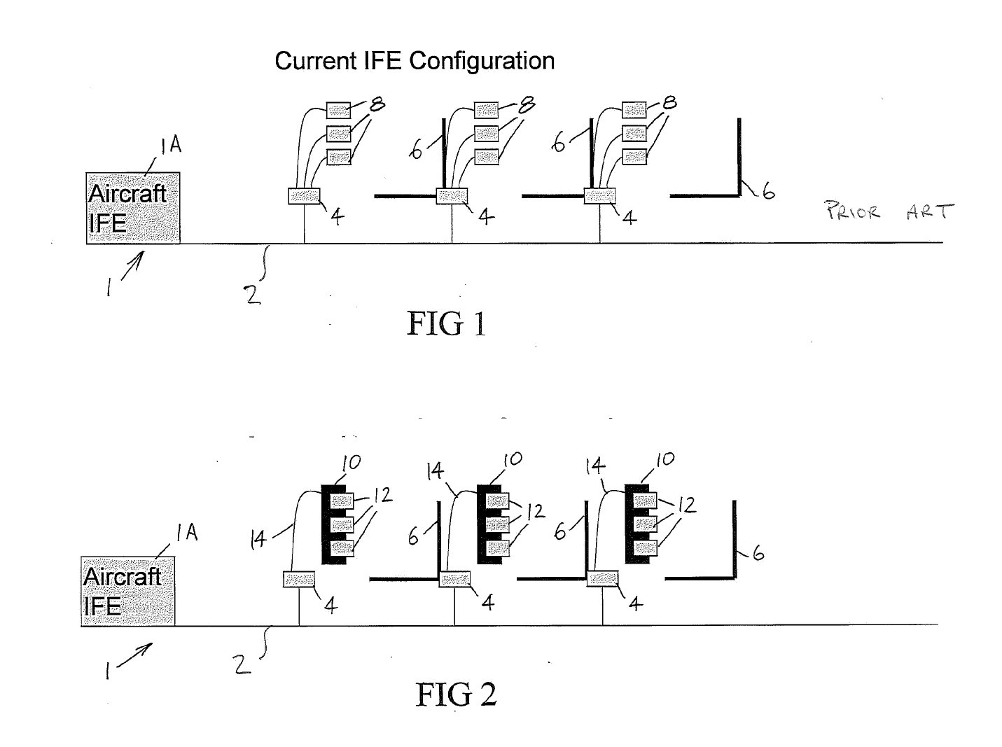

Referring to FIG. 1, a known IFE connector configuration is shown. The IFE system includes apparatus generally referenced 1 which comprises a central processor or server 1A. Server 1A delivers media over cabling 2 to one or more seat distribution units 4 associated with one or more seats 6.

Each seat distribution unit 4 delivers the entertainment media to devices present in, on or in the vicinity of, each seat to make the media available to the user. The devices typically include a visual display unit such as an LCD screen (not shown) and a number of connection sockets 8 which are mounted on or adjacent to each seat. The sockets 8 may include a variety of connector types. For example, one connector type may comprise a USB socket into which a user may plug a USB plug for connection to a laptop, a personal digital assistant, a mobile telephone or MP3 player, for example. Another connector type may be a power socket to enable a user to use or re-charge a laptop. Yet another connector type may be one which is not used for a user peripheral device, but is instead a socket for use by a component or device which remains in the aircraft, for example the LCD monitor (VDU) which is commonly attached to the seat back. Yet another common use for a connector 8 is a headphone socket, particularly a noise canceling headphone socket.

As outlined above in this document, with such a wide variety of possible connector types which may be required by various passengers, there is a difficulty with specifying the connector types that are required, and for upgrading these over time. For example, there can be a considerable time lag between placing an order for an aircraft and the time at which the aircraft is ready for passenger service. Over that time, a connector type being specified at the manufacture stage by an airline may have become redundant, or there may be increased demand for another type of connector arrangement. It can be difficult to accommodate these changes. Furthermore, after an aircraft has been in service for some time, the connector type required by passengers may well have changed. Physically removing and replacing the connector arrangements in each seat is a very expensive and time-consuming exercise, particularly since the cosmetic appearance of the seat fit-out and safety are important factors.

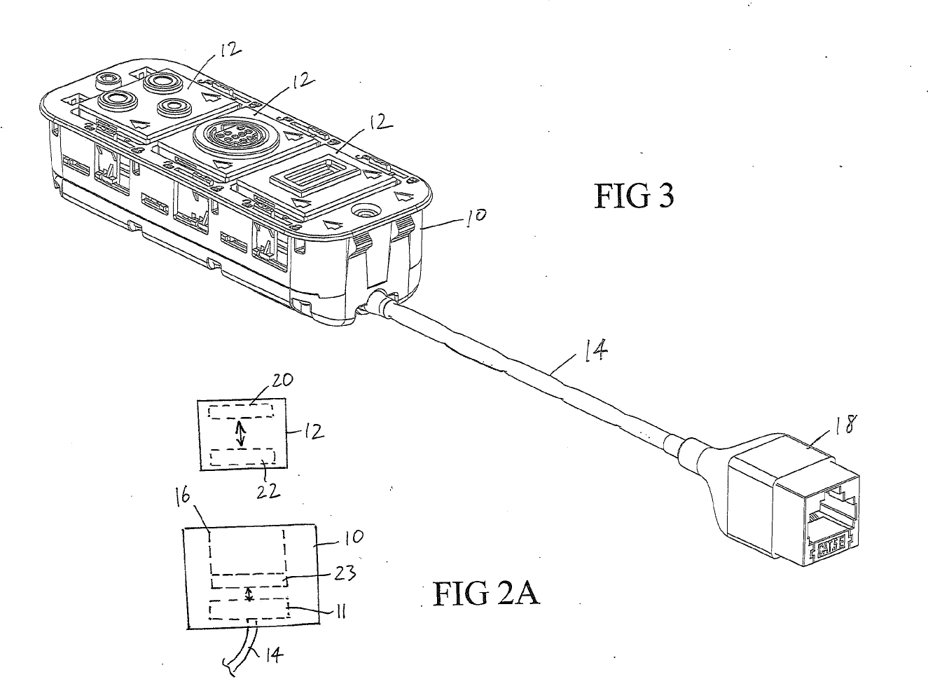

Turning now to FIG. 2, a schematic for a new connector arrangement is shown. In FIG. 2, and the remainder of the drawing Figures, like reference numerals refer to like features.

In the system shown in FIG. 2, a connector module receiver 10 is provided in the form of a seat-located connector socket. The receiver 10 carries one or more selectively removable connector modules 12. As can be seen from FIG. 2, in this embodiment there is a single standard data connection or harness 14 between the seat distribution unit 4 and the socket or sockets, unlike the known arrangement of FIG. 1, in which a plurality of individual connections are required between seat distribution unit 4 and each of the sockets 8. In this embodiment the standard data connection 14 may include a single data communication path and an appropriate power supply cable. However, those skilled in the art will appreciate that the connector system according to the invention may in other embodiments (not shown) be provided with a multiple connection between the receiver 10 and the IFE system, for example an analogue connection and a separate digital connection.

Turning to FIG. 2A, one of the connector modules 12 and the receiver 10 are shown diagrammatically. As will be described further below, in one embodiment the module 12 generally includes a component interface 20 and a receiver interface 22. The receiver 10 generally includes one or more receiving regions such as one or more pockets 16, a module interface 23 to connect with receiver interface 22 of the module, and may include a recognizer 11 if necessary. The recognizer may be embodied in software or in appropriate circuitry and may include a processor, as discussed further below. Those skilled in the art to which the invention relates will appreciate that the recognizer and/or processor does not need to be physically located in the receiver 10.

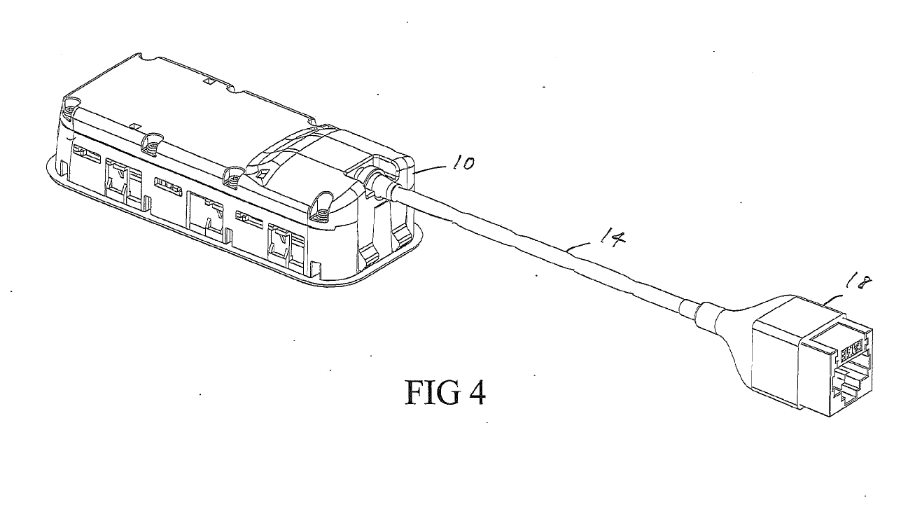

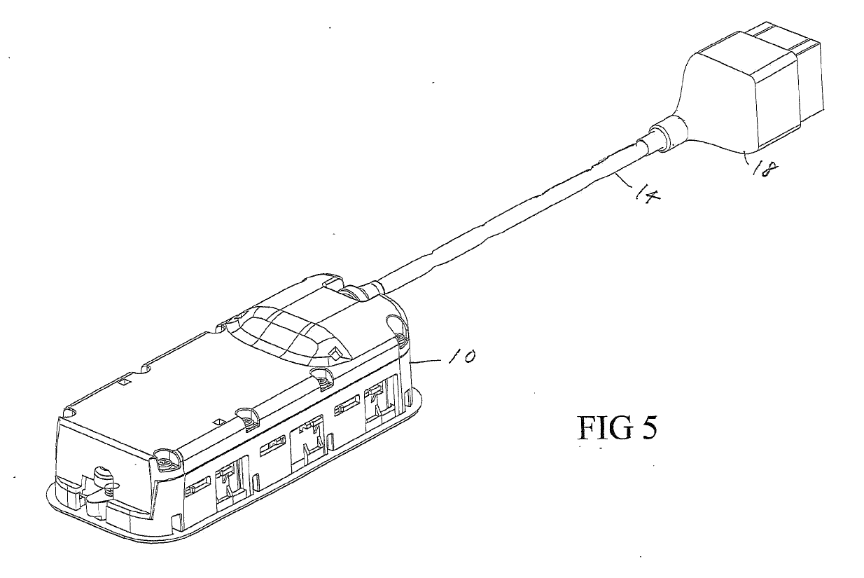

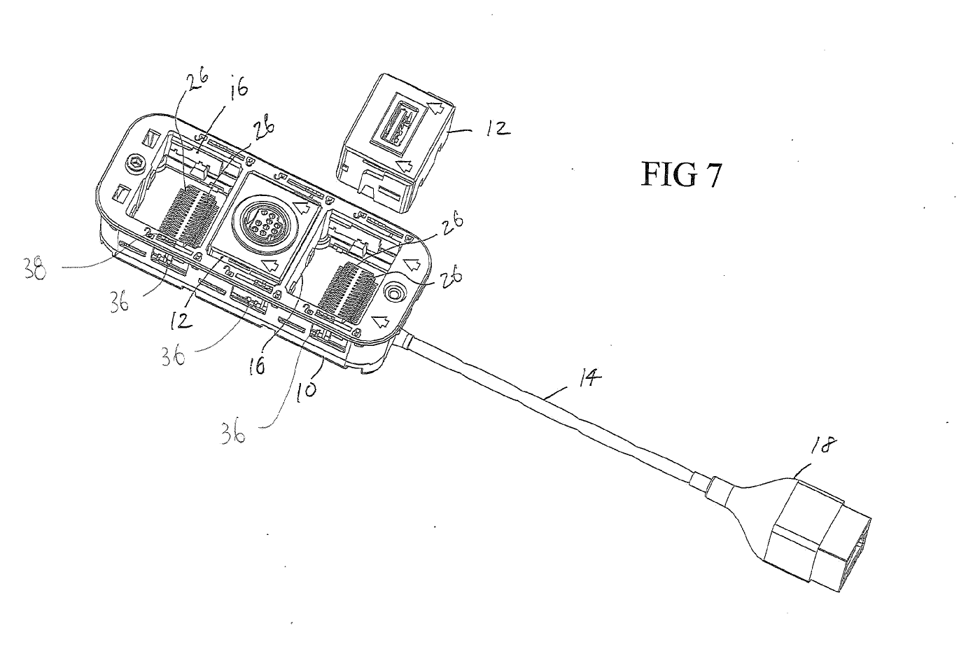

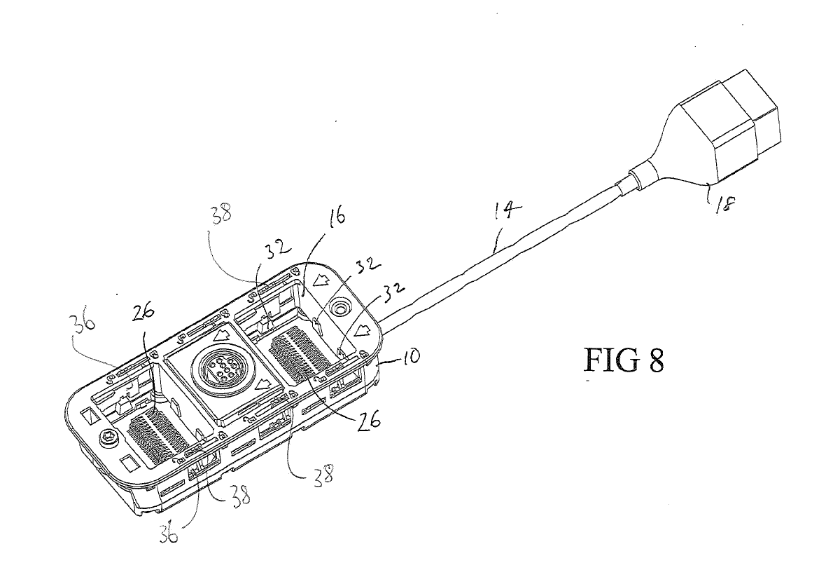

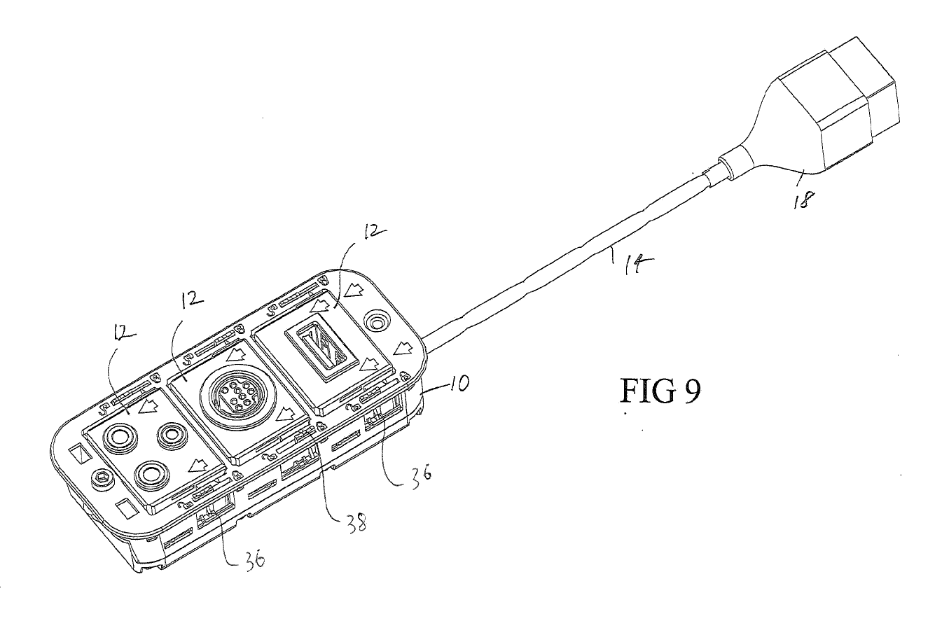

Turning to FIGS. 3 to 9, an embodiment of the connector module receiver 10 and connector modules 12 are shown in more detail. As can be seen from those figures, the connector module receiver 10 includes a number of pockets 16 in which the connector modules 12 may be located. The module interface 23 in this embodiment consists of electrical contacts 26. Also illustrated is the communication cable 14 from the receiver 10 which terminates with an appropriate connector 18 for connection with the IFE system via seat distribution unit 4 for example.

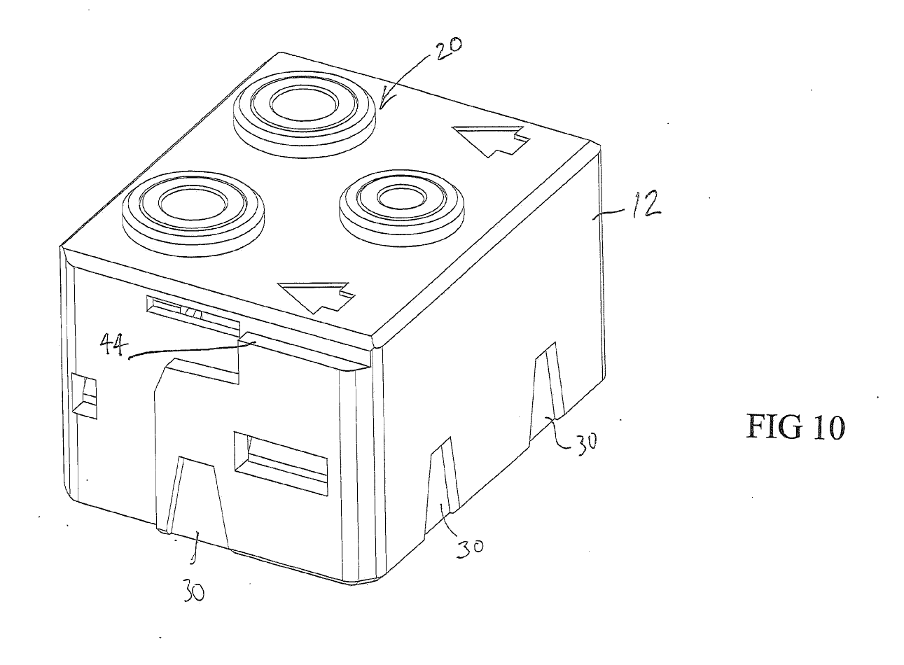

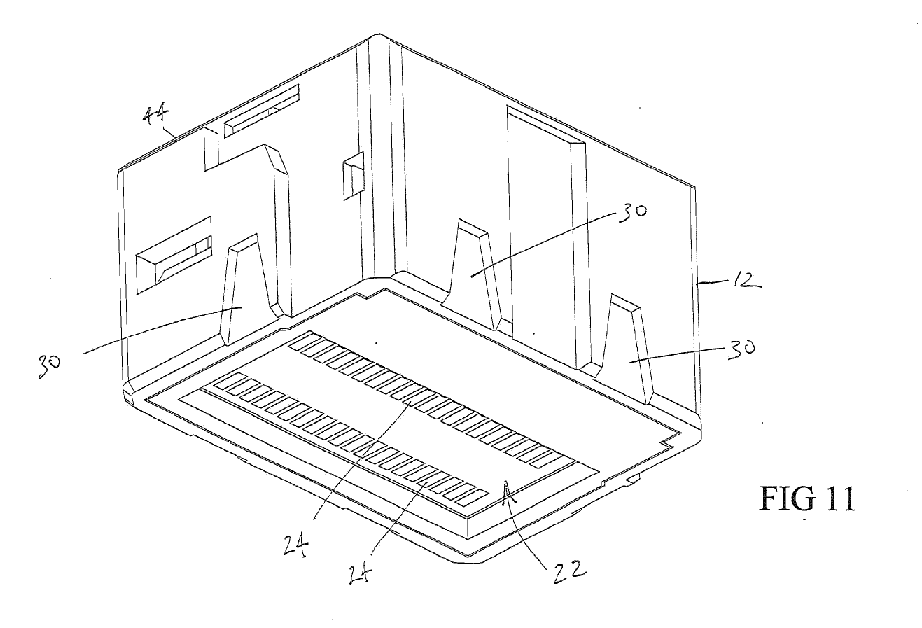

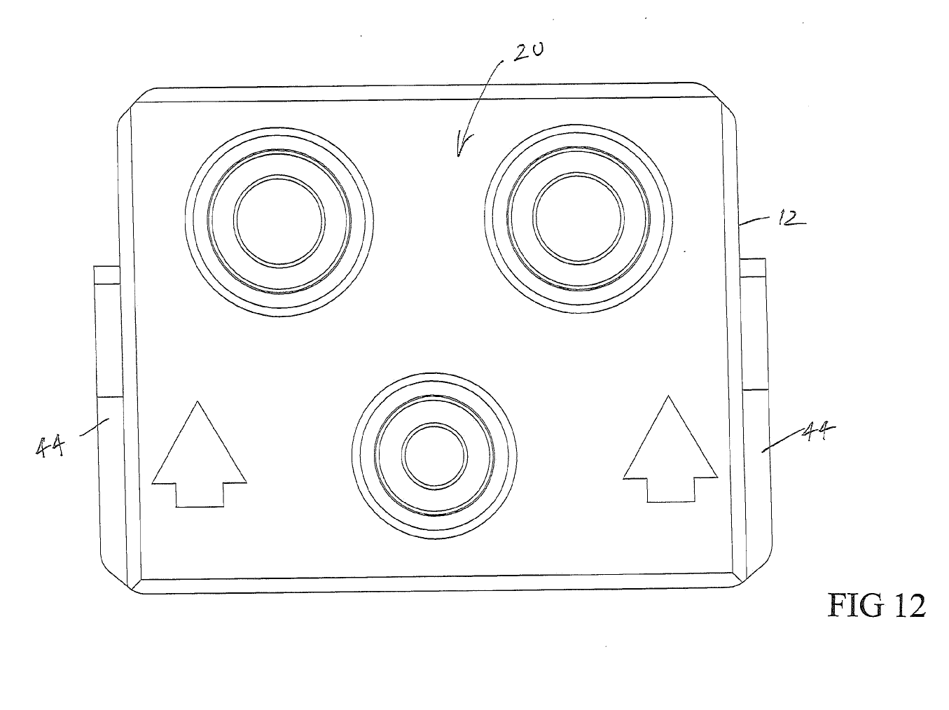

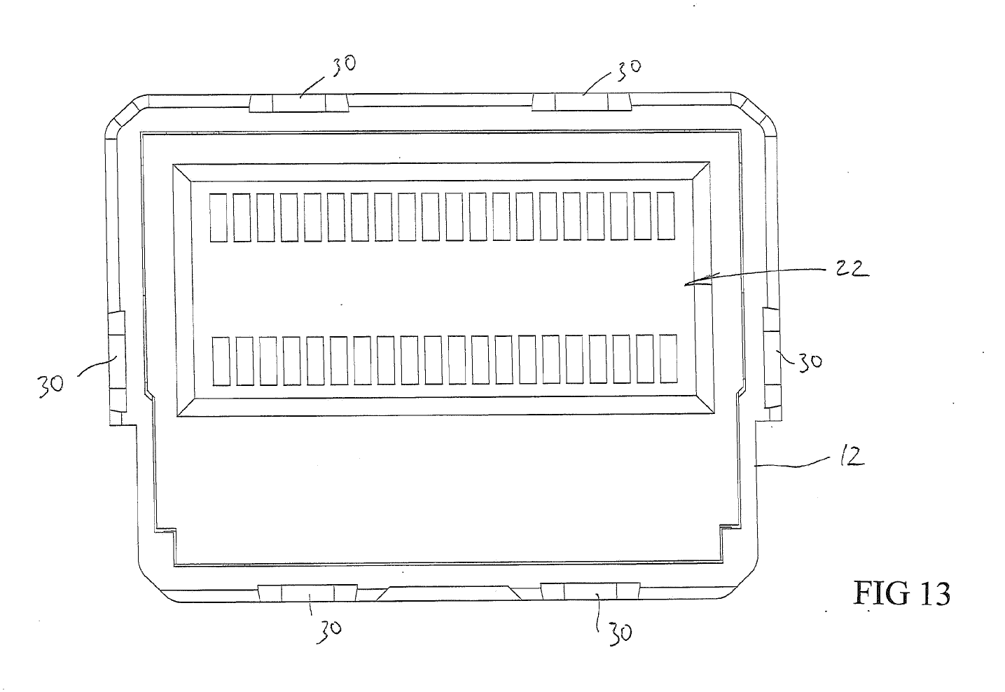

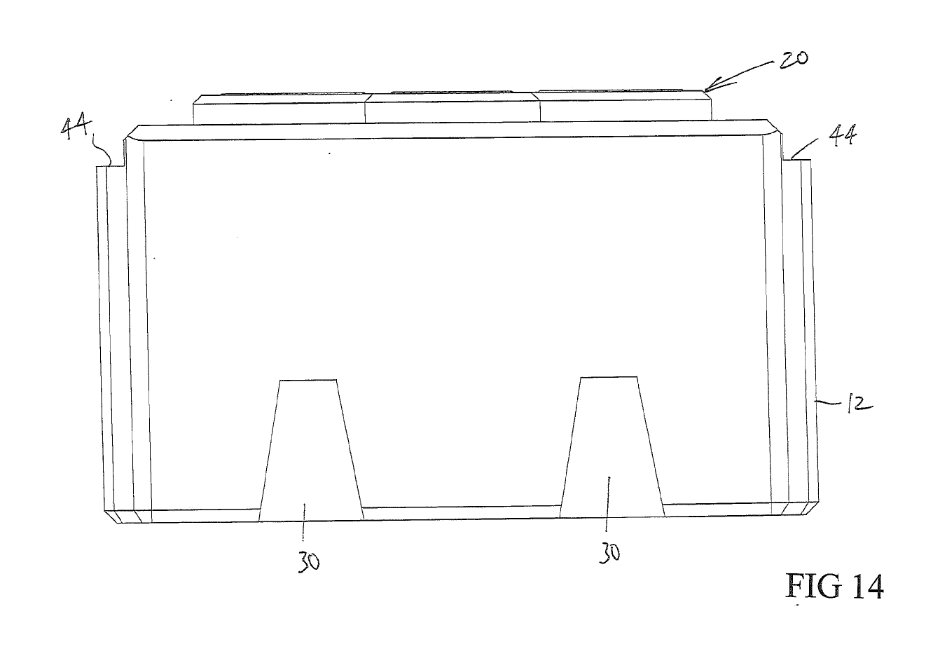

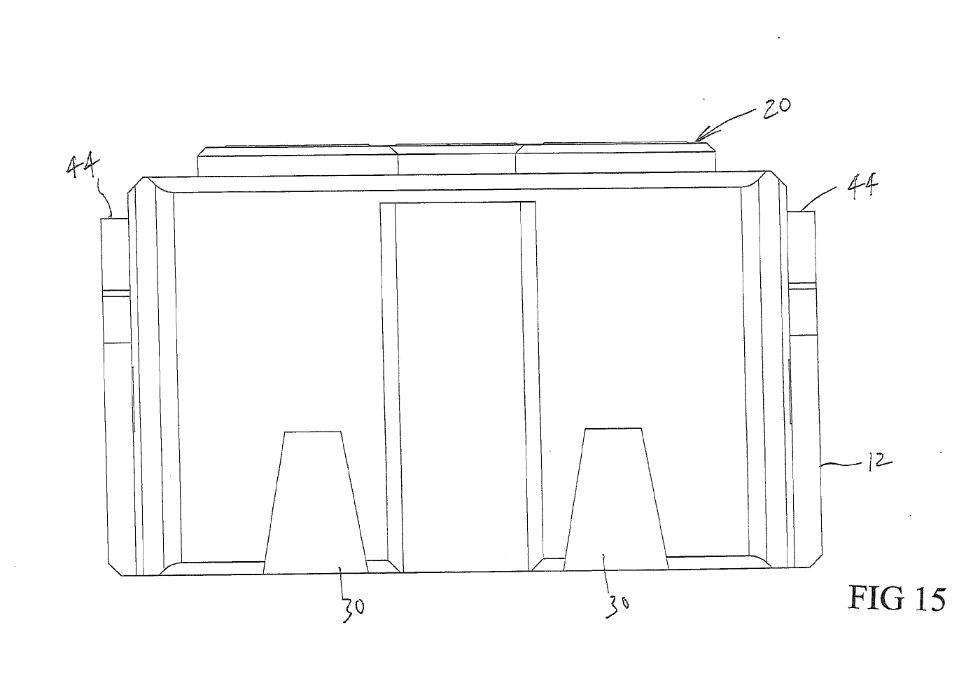

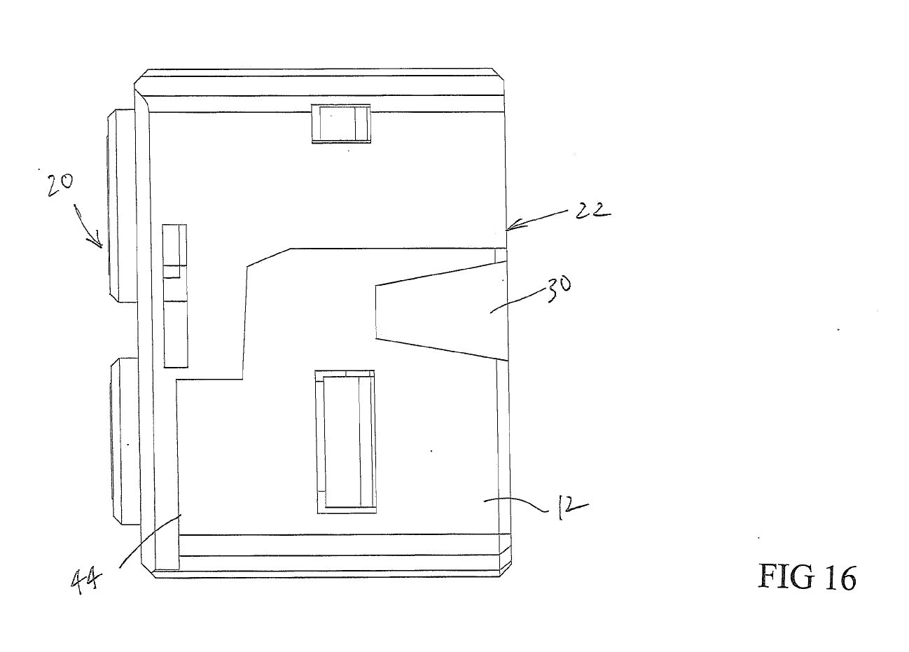

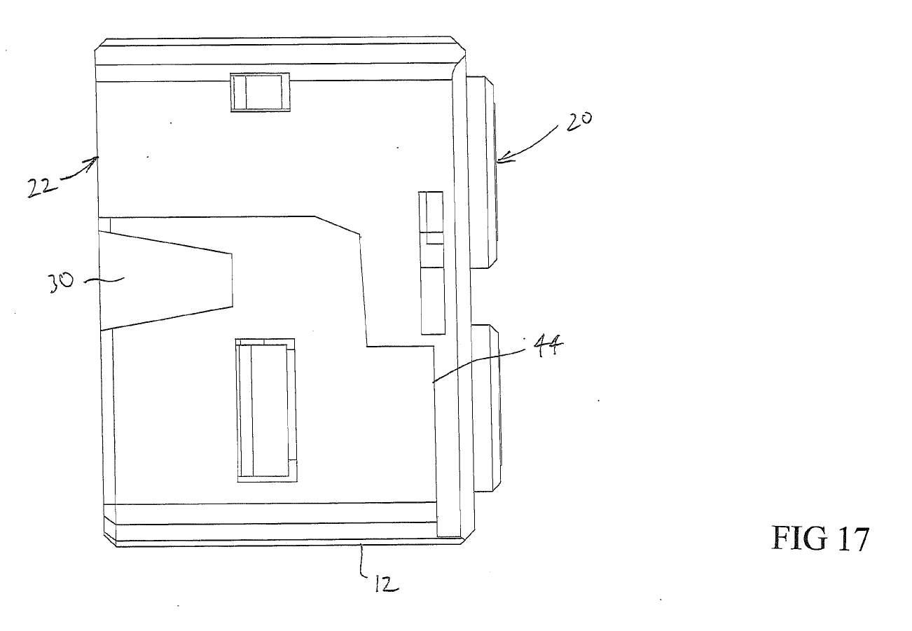

Referring now to FIGS. 10 to 17, an embodiment of connector module 12 is shown in greater detail. Referring to those Figures, the module 12 includes a component interface, generally referenced 20 and a receiver interface generally referenced 22.

As can be seen from FIGS. 3 to 9, the component interface 20 may take a number of different forms, depending upon the connector type which connector module 12 is required to implement. In the example shown in FIGS. 10 to 17, interface 20 comprises a three pin socket for receiving a three pin plug such as a noise cancellation headphone plug, for example. Apart from receiving a plug, the interface 20 would in some embodiments itself comprise a plug if necessary, and, rather than providing a physical connection, may comprise an emitter for example an infrared, WiFi or Bluetooth emitter device for interfacing with a component that supports an infrared, WiFi or Bluetooth communication connection. Without limitation, the interface 20 may implement any consumer or aircraft connector or emitter type such as, but not limited to, MiniDin, ARINC Standards, USB, HDMI, Infrared, WiFi, Bluetooth, RJ45 amongst others.

Those skilled in the art will appreciate that the interface 20 will depend on the connector type that the particular module 12 is required to implement. Therefore, each connector module 12 requires a particular electrical communication when received by or docked into the receiver 10, depending on the connector type it is required to implement.

The receiver interface 22 may, in the embodiment illustrated, consist of electrical contacts 24. In use, these make contact with corresponding or complementary electrical contacts 26 located in the base of each of the pockets 16 in the receiver 10.

In one embodiment, each module includes internal circuitry, or software, to enable the required data type to be supplied to the receiver 10.

In another embodiment, each connector module has a property which allows the connector type to be recognized by the receiver 10. In one embodiment, the recognition may be achieved by the arrangement of electrical connectors on interface 22, or simply by which of the connectors on interface 22 make an electrical connection with a component to which the relevant connector module 12 is connected via interface 20. Alternatively, the interface 22 or module 12 may have a physical property such as a contour which opens or closes a switch, for example at a particular location on the receiver 10 and which is in turn used by the recognizer to recognize the connector type supported by the module.

However, if a broad range of connector types are to be supported, then the arrangement can be complex as the recognition needs to determine parameters such as data types, power and other electrical communication and how that is conducted to each connector module once that module is docked or located into the receiver 10. Therefore, in various embodiments of the invention, recognition may occur in one or more of the following ways:
1. Providing the interface 22 of each connector module with a selected arrangement, or pattern of electrical connectors for engagement with the receiver connector arrays 26 of the module interface. Therefore, for example some electrical contacts may be missing so that it is only the electrical contacts that are relevant to the particular component interface 20 that is supported by the module that are active.
2. “Soft” identification. In this embodiment, recognizer 11 detects the presence of the connector module 12 and determines the type of interface 20 that the module supports by determining a property of the connector module electrically. In one embodiment this may occur by having a number of contacts in the connector array 24 at the base of each module used solely for identification purposes. Thus passive components in the module may be connected to the identification contacts to provide detectable predetermined properties, each property signifying a particular connector type. As another example, an embodiment may include a memory which can be accessed by the recognizer 11 to obtain information on the connector type and which may additionally include a unique identifier relating to that module, or other identifier, by which the authenticity of the module may be verified. Once the recognizer in the device 10 recognizes the connector type, then the recognizer, or additional circuitry in or associated with the receiver 10 (for example a microprocessor) soft switches appropriate data types to the module 12 and performs any required processing to decode or implement the data type.
3. A further option is a combination of options a, and b, above. In this embodiment, each connector module may have electrical contacts that are determined by the connector type, customized to a particular connector type, and also include an electrical identifier, such a unique identifier. In this embodiment, some of the conduction parts are soft switched by the device 10 while others may simply be determined by the physical electrical contact arrangement between the device and the module 12.

In one embodiment, the connector module receiver contains or is associated with software updatable digital decoding, encoding and encryption functionality to enable a wide range of connector types and to allow for new connector types to be electrically enabled by an IFE system. This digital functionality is designed to accept multiplexed encoded data streams from the IFE which simplifies the IFE cabling architecture. The digital functionality therefore allows for change in data streams as consumer audio product connectivity and associated data flows change. Furthermore, the digital functionality provides support data switching and data type encoding and encryption in a suitable format for assorted connector types.

Therefore, the digital functionality in or associated with the connector module receiver separates and switches conventional digital data streams, specialized encryption digital data streams, and analogue signal streams to the appropriate connector from one or more multiplex encoded inputs. This functionality may be provided as part of, or separately from, the recognition function of recognizer 11.

Referring to FIGS. 10 to 17 it can be seen that in the embodiment illustrated the side and end walls of each module 12 include a tapered recess 30. Those skilled in the art will appreciate that not all walls need to include a tapered recess, and alternatively, the recess may instead comprise a projection having one or more tapered walls. The recesses 30 are complemented in receiver 10 by corresponding tapered projections 32. As can be seen from the drawings, the tapers allow a taper fit to be achieved between each of the connector modules and the receiver. In this way, each connector module is guided into the receiver, and the taper fit ensures a secure engagement so that there is no relative movement between the modules and the receiver in use (which overcomes problems due to vibration in an aircraft environment).

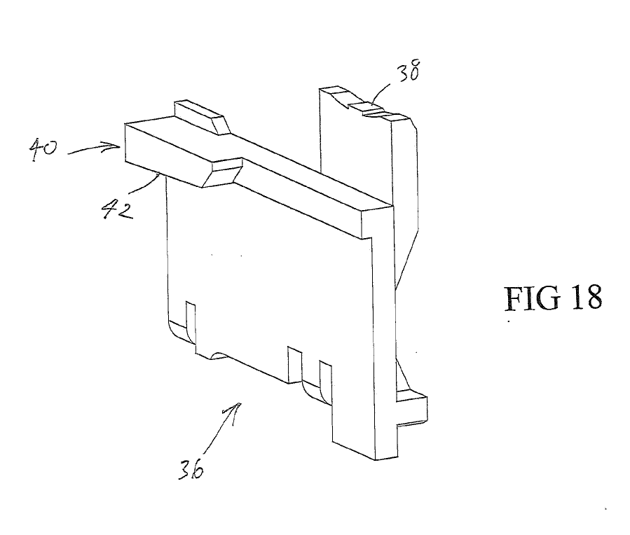

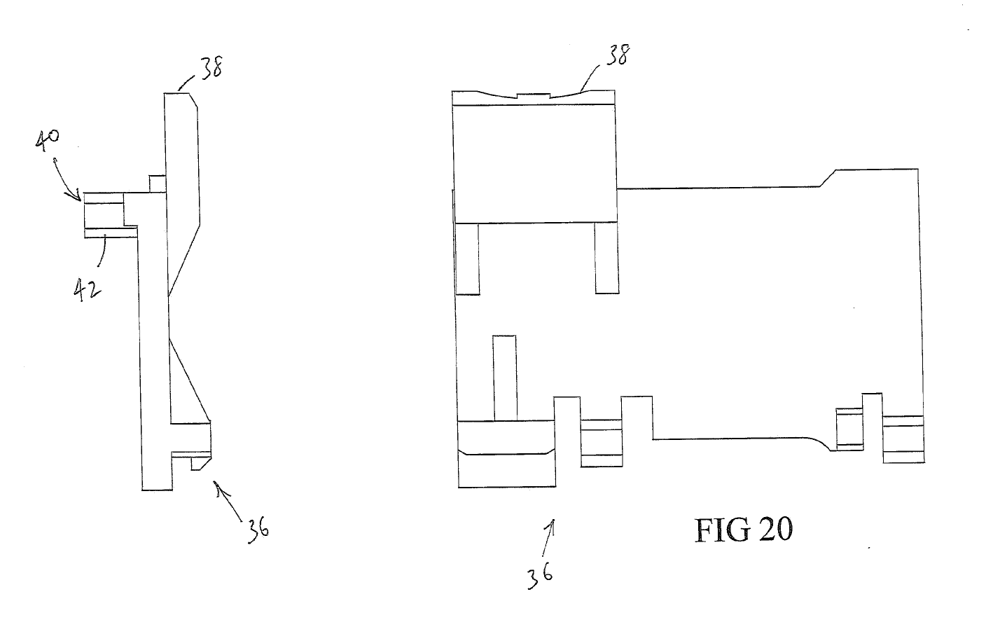

Referring now to FIGS. 18 to 20, a locking component, generally referenced 36, is shown having a user contact portion 38 and a retaining portion 40 which has a contoured contact wall 42 for engaging with a surface 44 on the side of each module 12.

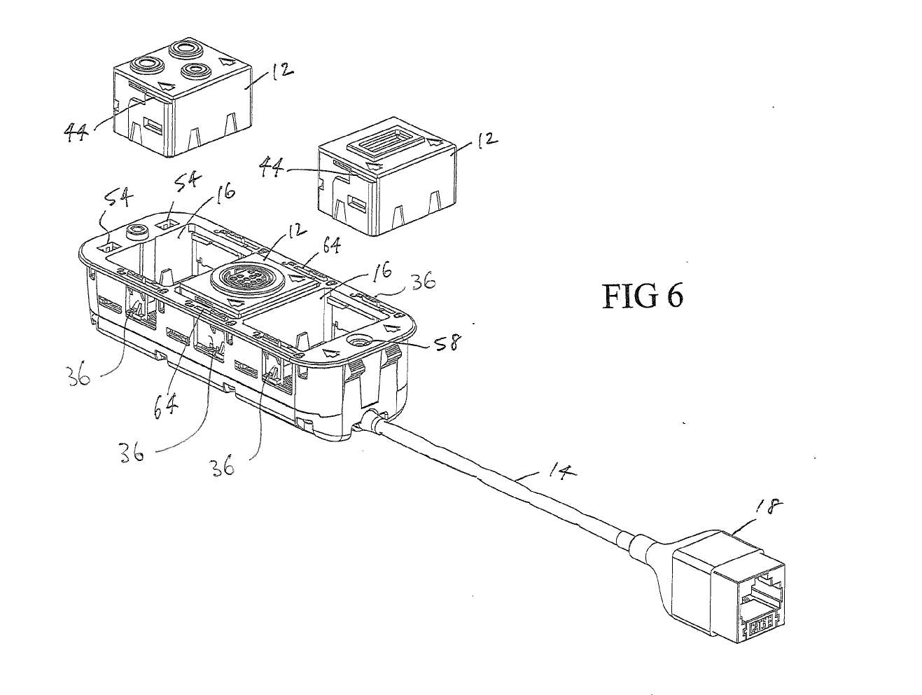

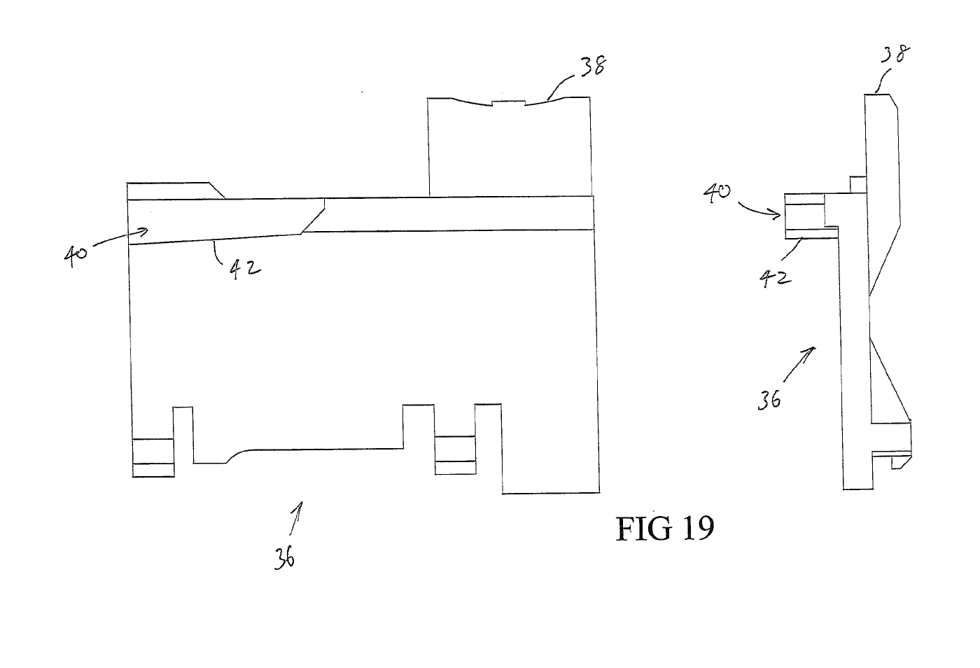

In one embodiment, a locking member 36 is provided in the receiver 10 on each side of the connector module packet 16, as can be seen in FIGS. 3-9. Referring particularly to FIGS. 6 to 8 it can be seen that the locking members 36 are slidably disposed in the receiver 10. Still referring to FIGS. 6 to 8, it can be seen that the locking members 36 that are positioned in the first and last pockets 16 of the receiver 10 are in the unlocked position so that modules 12 may be positioned in each of the pockets. When a connector module 12 is placed in a pocket 16, then the user can manipulate contact portion 38, using a finger or fingernail for example, to drag the locking member in a slideable motion in a direction toward the data cable 14 which will draw surface 42 over surface 44. As can be seen from FIG. 19, surface 42 is contoured, and this embodiment comprises an inclined plane or ramp, so that the member is activated by moving it toward a locked position, the module 12 is brought into a firm and secure engagement with the receiver 10. Those skilled in the art will appreciate that other forms of surface 42 may be used apart from a simple inclined plane or ramp. For example, a curved, cam-like surface may be used. Similarly, surface 44 may be contoured as an alternative to contouring surface 42.

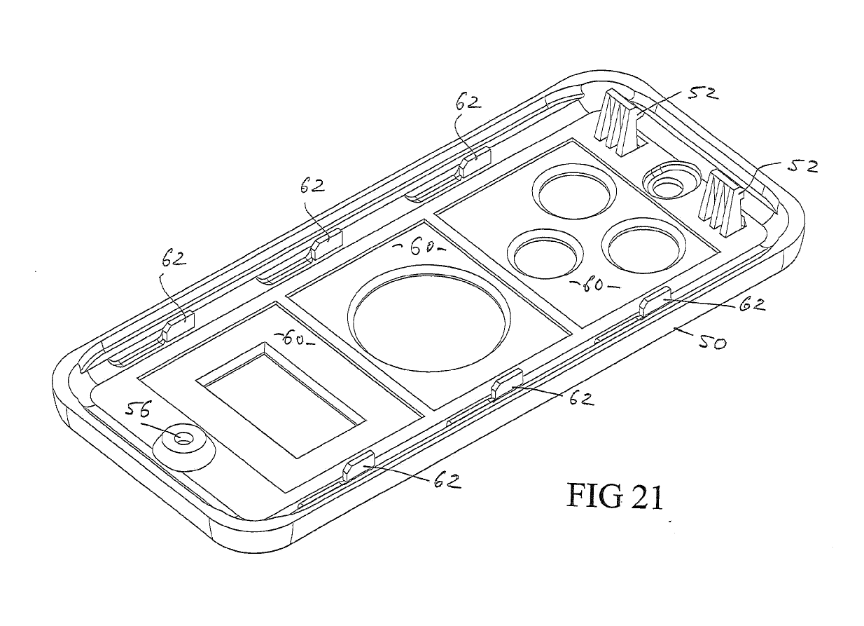

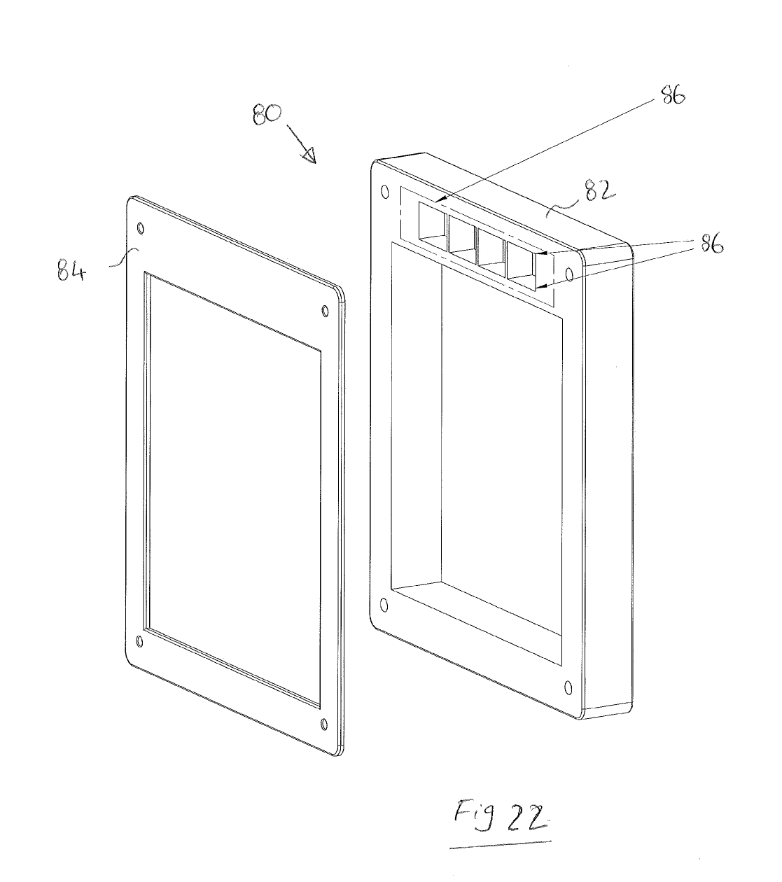

Turning now to FIG. 21, a faceplate or fascia is shown for placement over the receiver 10. The faceplate 50 in this embodiment includes legs 52 which engage with apertures 54 in the receiver 10, and together with an appropriate fastener (not shown) which may be located through apertures 56 and 58, allows the faceplate 50 to be attached to the receiver. Faceplate 50 may include cutouts or windows 60 that correspond to the physical form of the component interfaces 20 provided by the connector modules. The window 60 may be removable or replaceable depending upon the type of connector module 12 which is to be used, and in some embodiments of the invention, windows 60 may simply be openings. Faceplate 50 also includes a further locking mechanism comprising projections 62 which in use are received in the recesses 64 in the receiver 10 that are created when the locking member 36 is disposed in the locked position. Therefore, the faceplate 50 cannot be properly located in place on the receiver 10 until all of the locked members are correctly actuated. Furthermore, once the faceplate is correctly in place, the locking members cannot be inadvertently moved to an unlocked position, for example due to vibration in use.

Although a plurality of individual selectively removable connector modules 12 are shown, it will be appreciated that a single selectively removable component which engages with connector module receiver 10 may be provided with a plurality of different component connectors. Therefore, in an alternative arrangement, a group of component interfaces of the same or different connector type may be removed and replaced as a single module.

The connector module receiver 10 is adapted for placement in or adjacent to an aircraft seat, for example in a seat back or in a seat armrest. In one embodiment, the faceplate 50 allows cosmetics to be customized or changed easily and the component modules 12 may also include customized fascias so that the cosmetic appearance of the connector assembly is pleasing and consistent. Furthermore, blanks may be provided, should the airline opt not to include a full range of connectors in each receiver 10.

In one embodiment the receiver 10 includes appropriate hardware and software to allow the required connector type to communicate with the seat distribution unit 4 (or the IFE system) over the standardized harness 14. Therefore, in one embodiment, the seat connector socket 10 has the ability to allow devices connected to sockets 12 to communicate into the IFE system. Therefore it may contain the following functionality:

1. compression/decompression

2. routing of data, video, audio

3. audio/video enhancement or customization

4. active noise cancellation functionality

5. detection of socket type functionality

6. authentication capabilities.

Similarly, in one embodiment, the receiver 10 conforms to standardized seat cutout and a standardized mounting distance which enables faceplate options for multiple colors and styles, without having to change the seat or arm rest recess in which it is located.

In other embodiments the IFE system includes functionality to enable communication with devices connected to connectors 12.

In a preferred embodiment the connector functionality described above can be provided in or as a part of a VDU housing or surround. For example, the receiver 10 for the connector module may be built into the screen surround of the VDU. Furthermore, one or more of the modules 12 may comprise a camera such as a webcam. One or more of the other modules may comprise a microphone. In this manner an audio visual communication system can be provided for the passenger.

The signal processing required may be performed by the receiver or an associated processing device such as the VDU processor, or a separate adjunct processor in communication with the seat distribution unit (such as the processing module described in our co-pending U.S. patent application 61/130,250 entitled Media Enhancement Module).

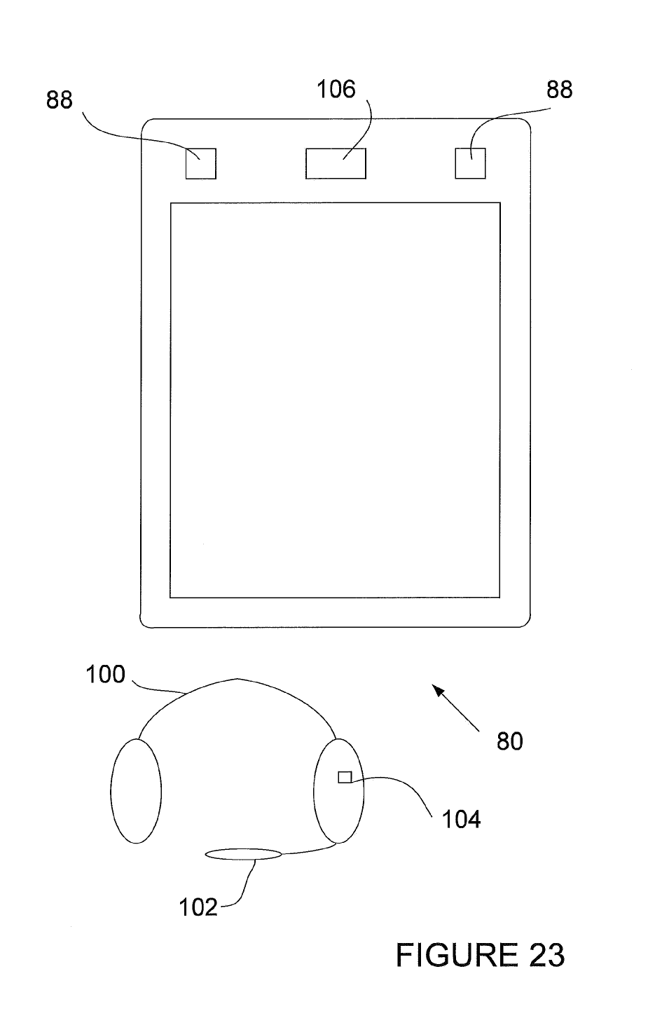

In another embodiment hardware for performing appropriate signal processing may be located in the VDU housing. Such an embodiment is illustrated in FIG. 22 in which a VDU, generally referenced 80, has a housing or surround 82 and a faceplate 84. The housing 82 includes one or more pockets or recesses 86 which provide space for hardware. For example the hardware may include functionality sufficient to implement one or more of the following:
1. A video codec having one or more of the following functions:
   (a) Face recognition optimization
   (b) Image stabilization
   (c) Autofocus
2. One or more microphones 88 (see FIG. 23). The microphones are adapted to receive a voice signal from the passenger. In one embodiment an array of microphones is provided. The array may be directed or suitably arranged to receive sound from the passenger and substantially exclude sound from the area adjacent to the passenger. In another embodiment an audio signal processor filters unwanted sound from the audio signal received from the one or more microphones.
3. RFID to provide an identification function for an audio transducer device for use by the passenger with the VDU and/or camera. For example the audio transducer device may comprise a headset, a microphone, or a headset 100 that includes a microphone 102 and an RFID chip 104, as shown in FIG. 23.
4. An Infrared communication link for IR communication with an audio transducer device such as that described immediately above.
5. An RF communication link for RF communication with an audio transducer device such as that described above.
6. A camera 106 (as an alternative to use of a receiver 10, or as a module 12).
7. A Bluetooth communication link for communication with an audio transducer device such as that described above. In one embodiment an IR communication link may be used to identify the audio transducer device and a Bluetooth link may be used to effect transmission/reception of the audio information.
8. A communication link for communication with an audio transducer device such as that described above.
9. A barcode reader.
10. An Inductive Power Transfer primary supply to allow a secondary pick up associated with an appliance such as a headset, microphone or telephone to be powered and/or charged therefrom.
11. A communication interface with the IFE system or other processor, for example via USB, I2C, RS232.
12. A crew control function to allow aircraft personnel to deactivate or over ride video and/or audio functionality in the event of vehicle maneuvers such as take off or landing, passenger announcements, or emergency situations.

What is claimed is:

1. A passenger visual display unit (VDU) having a camera associated therewith, the camera being adapted to capture an image of a passenger using the VDU.

2. The passenger VDU of claim 1 wherein the camera is incorporated into a housing of the VDU.

3. The passenger VDU of claim 1 wherein the camera is incorporated in a screen surround of the VDU.

4. The passenger VDU of claim 1, wherein the VDU is in communication with one or more microphones adapted to receive a voice signal from the passenger.

5. The passenger VDU of claim 4, wherein an array of microphones is provided.

6. The passenger VDU of claim 4 wherein an audio signal processor filters unwanted sound from the audio signal received from the one or more microphones.

7. A passenger visual display unit (VDU) including an image processor for providing an image captured by a camera in an appropriate digital format for provision to a communications or information system.

8. The passenger VDU of claim 7 wherein the communications or information system comprises an IFE system.

9. The passenger VDU of claim 7 wherein the processor comprises a video codec comprising one or more of the following functions:
1. Face recognition optimization
2. Image stabilization
3. Autofocus.

10. The passenger VDU of claim 7 wherein the VDU is in communication with one or more microphones adapted to receive a voice signal from the passenger.

11. The passenger VDU of claim 10 wherein an array of microphones is provided.

12. The passenger VDU of claim 11 wherein the array is directed to receive sound from the passenger and substantially exclude sound from the area adjacent to the passenger.

13. The passenger VDU of claim 10 wherein an audio signal processor filters unwanted sound from the audio signal received from the one or more microphones.

14. A video communication system for a vehicle passenger, the system including an image processor for providing an image captured by a camera in an appropriate digital format for provision to a communications or information system.

15. The video communication system of claim 14 wherein the system includes an audio interface to provide a voice signal from the passenger in an appropriate digital format for provision to a communications or information system.

16. A video communication system of claim 15 wherein the system further comprises self identification of an audio device such as a microphone and/or headphone.

17. The video communication system of claim 16 wherein an audio signal processor filters unwanted sound from an audio signal received from one or more microphones.
